(19) United States
(12) Patent Application Publication
(10) Pub. No.: US 2004/0177226 A1
(43) Pub. Date: Sep. 9, 2004

(54) Storage system with snapshot-backup capability and method for the same

(76) Inventor: Chun-Po Chen, Taipei (TW)

Correspondence Address: J.C. Patents, Inc., 4 Venture, Suite 250, Irvine, CA, 92618, US

(21) Appl. No.: 10/779,302

(22) Filed: Feb. 12, 2004

(30) Foreign Application Priority Data
Mar. 6, 2003 (TW) 92104764

(51) Int. Cl. G06F 12/16

(52) U.S. Cl. 711/162

(57) ABSTRACT

The present invention provides a storage system with snapshot-backup capability and method for the same. The storage system is electrically connected to a main system, and includes a storage device and a storage controlling unit therein. The storage device consists of multiple primary data blocks and backup data blocks, and the storage controlling unit includes a chip controller and an embedded driver software. The steps of the storage method are as follows. The storage controlling unit receives at least a newly stored data from the main system and determines whether the newly stored data is different from at least a previously stored data located in the data blocks of the storage device. While a difference between the newly and previously stored data is identified by the storage controlling unit, each different previously stored data is snapshot backed-up to the backup data blocks and then the corresponding different newly stored data is written over the primary data blocks where said different previously stored data is located.

### CROSS-REFERENCE TO RELATED APPLICATION

This application claims the priority benefit of Taiwan application serial no. 92104764, filed on Mar. 6, 2003.

### BACKGROUND OF THE INVENTION

1. Field of the Invention

The present invention relates to a data storage system and a data storing method. More particularly, the present invention relates to the data storage system with a snapshot-backup capability and a method for the same.

2. Description of Related Art

In a data storage system with direct memory access (DMA) function of a host computer, storage is directly accessed without comparing the existent data stored in the system with the data that is intended to be stored. This storage system may be accessed without getting a central processing unit (CPU) of the host computer involved. However, this kind of data storage system has a fundamental problem. Directly accessing the storage without checking if data is already existed and unchanged in the storage system will waste the system resources doing the unnecessary storage work. As a consequence, the data storage system will need to be accessed more frequently, resulting in the data flow of the storage system being increased dramatically. This huge amount of data flow will not only slow down but also shorten the lifetime of the storage system. Because of the constraints mentioned above, the DMA function storage system is not suitable for fast data access and large amount of data backup.

To resolve the above mentioned problem, a storage system using a storage management software (SMS) is commonly used. The SMS is operating system (OS) dependent, that is, different OS will have its respective SMS to use. During a data storage process, SMS will make a snapshot-backup for data that is requested to be stored and then it will store the snapshot-backup to a different data storage section. For example, the snapshot-backup will be stored in a file server or a backup device. The SMS mechanism surely speeds up data backup time; however, it also introduces some drawbacks. In the case of a task that needs to be backed-up frequently, the SMS mechanism will take too much system resources to do the task. Under the intensive use of I/O port, system bus, memory, and CPU, the SMS slows the system down in a conspicuous way.

To further improve the performance of the data storage system, a mechanism that equips the system with an ability for data comparison and choosing of data storing method has been added to the SMS scheme. With this improvement, the data storage system will be able to choose the method of storing data after comparing the existed backup data with the data that is requested to be stored. This mechanism avoids unnecessary access to the data storage system and increases the lifetime of the system. However, this mechanism also adds quite an amount of additional workload of calculation and comparison to the CPU of the host computer. This workload makes the CPU less efficient especially to a CPU that has a huge amount of calculation workload or to a CPU that has a multi-data-access storage system.

### SUMMARY OF THE INVENTION

Accordingly, the purpose of the present invention is to provide a data storage system with a snapshot-backup capability and a method for the same. Upon receiving a data, the data storage system executes a data consistence examination and a data snapshot-backup if the data received is an update copy. With this provided mechanism, the lifetime of a data storage system can last longer and the storage backup time of the data storage system will be shortened without adding too much workload on a CPU of a main system, which is coupled to the data storage system. The present invention is particularly effective to the main system with a heavy-work loaded CPU or a multi-data-access storage system.

In one embodiment of the present invention provides a data storage system with a snapshot-backup capability. The data storage system is electrically coupled to a main system. The data storage system at least includes a storage device and a storage controlling unit. The storage device includes multiple data blocks and multiple backup blocks, and the storage controlling unit comprises at least a controller and a built-in driver. The data storage system works as follows. The main system sends a data that needs to be stored to the data storage unit. Upon receiving a data storing request from the main system, the data storage system first looks up its storage records to see if this data has its corresponding storage record created. If the answer is no, the data is stored without a question asked and a new storage record is created for the data. On the other hand, if the answer is yes, the data storage system will follow the storage record and its block-mapping table to find out the corresponding data that was previously stored. Next, a data comparison task is performed among the data that is available to be stored and the data that is already stored in the data blocks in the storage. The difference between these two copies of data is identified by the storage system. The storage system will then copy the old piece of data to its backup blocks and leave the blocks that hold the old piece of data to store the update data. During the procedure of moving old data and up-to-date data, both the snapshot-backup of the old data and the snapshot-backup of the up-to-date data are stored to the block-mapping table.

The second preferred embodiment of the present invention applies the data storage system and method defined in the first preferred embodiment to an interface device that is, for example, a storage interface card. This kind of storage interface card can be electrically coupled to a main system, and the storage interface card at least consists of a storage controlling unit and an I/O port. The storage controlling unit comprises at least a controller and a built-in driver. The data storage system with an interface card works as follows. The storage controlling unit on the interface card receives the storage data from the main system. Based on the data distribution record, the storage controlling unit will be able to compare and to find out the differences between the available data that is coming from the main system and the data that is already stored in the storage. Again, after the comparison, the out-of-date data is copied to the backup block of the storage device, and via the I/O port the up-to-date data replaces the out-of-date data in the data block of the storage device.

Last but not least, the third preferred embodiment of the present invention further utilizes the storage interface with snapshot-backup capability in a mother board that is equipped with the main system

As a summary, the data storage system architecture of the present invention utilizes the storage controlling unit in doing data comparison, snapshot processes, and data management so that the performance of the main system will not be decreased or be influenced by a huge amount of data storage operation. Furthermore, on the storage controlling unit's own initiative, the snapshot-backup of the differences between the current copy and the previous copy of data is automatically taken and stored. During all kinds of hardware or software failure, both of the unsaved and saved data have a better chance to survive and be recovered quickly from a not anticipated failure.

For the purpose of a better description of the usage, functionality, and advanced features of the present invention, the preferred embodiments accompanied with diagram demonstration are as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a circuit block diagram that depicts the first embodiment of the present invention.

FIG. 2 is a circuit block diagram that represents the second embodiment of the present invention.

FIG. 3 is a circuit block diagram that demonstrates the third embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

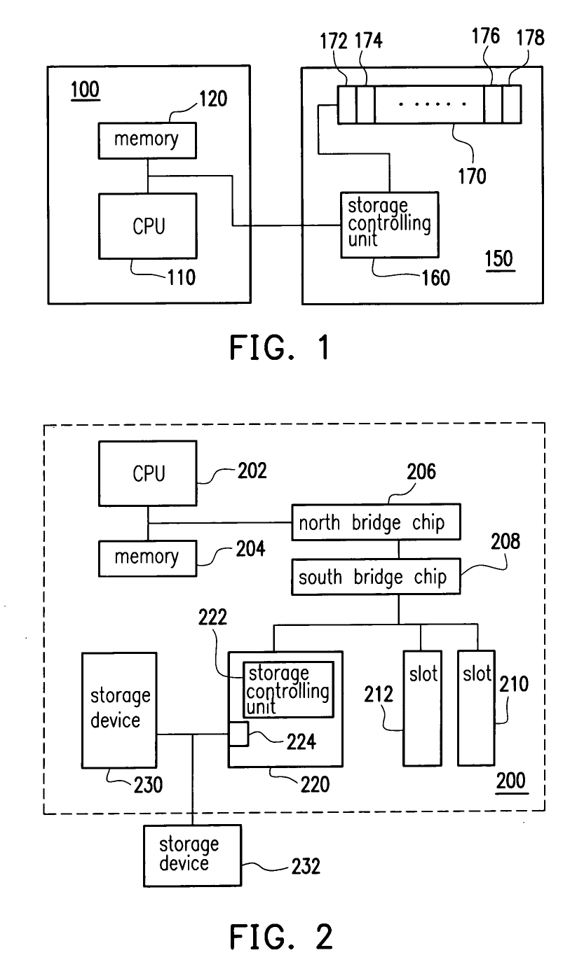

FIG. 1 represents a data storage system with a snapshot-backup capability electrically coupled to a main system of a first preferred embodiment of the present invention. In FIG. 1, the data storage system 150 with the snapshot-backup capability is electrically coupled to the main system 100; as a result, the main system 100 can store and retrieve data from the data storage system 150 via the electric coupling. The storage system 150 includes at least a storage controlling unit 160 and a storage device 170. The storage device 170 includes multiple data blocks and snapshot data blocks 172-178. The storage controlling unit 160 at least includes a data controller or a processor level computer chip, and a built-in device driver, for example, a Linux program. As a contrast, a data storage technology that is commonly used in the market exploits a main system central processing unit (CPU) 110 and a storage management software (SMS) of the main system 100 to do snapshot-backup and the ordinary storage tasks. This commonly used mechanism not only exhausts the CPU but also lessens the backup efficiency. On the other hand, in the present invention, every storage system 150 equips the storage controlling unit 160 with the ability to directly make a snapshot-backup on the incoming storage data without taking too much main system resource and without having the SMS running on the main system 100. As a result, the CPU 110 of the main system 100 can save calculation time from doing the tedious storage task. The present invention is designed to achieve this goal.

Based on the present invention, the data storage system with the snapshot-backup capability of the first preferred embodiment functions as follows. Upon receiving a storing data from the main system 100, the storage controlling unit 160 first analyzes the data. This analysis checks if this incoming data is already stored in the data blocks 172-178 in the data storage device 170. In other words, based on the data distribution record among the data blocks 172-178 and a block-mapping table, a comparison can be easily made between the receiving data and the data already stored in the data blocks and the difference of these two data can be identified. Note that the block-mapping table contains the most current data and the backup data mapping information. By following the block-mapping table, a newly stored data and its backup can be found.

During the data analysis procedure, if the storage controlling unit 160 can not find an entry for the receiving data, the storage controlling unit 160 will mark the data as a new one and store it to an available data block, for example, the block 172, in the data storage device 170. If the data analysis procedure does find an entry for the newly received data, the storage controlling unit 160 will then proceed to a comparison task among the newly received data and the data stored in the entry. Once the differences between these two copies of data is identified, the controller 160 will move the data difference in the old copy (a previously stored data) to the backup region and store the up-to-date data (newly stored data) to the data block where the previously stored data is stored. The mapping records of both of the previously stored data and the newly stored data are saved to the block-mapping table.

As addressed above, the block-mapping table contains both of the data mapping records that map to the newly stored data and previously stored data. This mechanism provides users a quick data recovery scheme. Once a user decides to have his/her old data back, via the block-mapping table, the storage controlling unit 160 will be able to easily copy the data stored in the snapshot-backup region to the primary data block so that the previously stored data is recovered effectively. The block-mapping table in the first preferred embodiment of the present invention is possible to be designed to hold the most recent backup copy only. Whenever the snapshot-backup happens, the current backup data replaces the old backup data that is stored in the snapshot-backup block. By this simple design, the storage controlling unit 160 can more efficiently do data comparison, data snapshot-backup, and data recovery.

Furthermore, if a data loss occurs between the main system 100 and the data storage system 150 and results in the data storage system 150 failing to store data correctly, the storage controlling unit 160 can automatically recover the lost data based on a data storage execution log file. The data storage execution log file contains the information of what has been executed and what experiences problems. Upon the system recovering from a software or hardware failure, the data storage controlling unit 160 automatically opens the data storage execution log file and finds out what has been executed and what hasn't. Based on the log file, the data storage controlling unit 160 continues the unfinished tasks. The unfinished tasks can be comparing two copies of data, making a snapshot-backup on the previously stored data, updating the block-mapping table, and storing the newly stored data to the corresponding data block. By using the data storage execution log file, the data storage controlling unit 160 can easily recover from a system failure and proceed to its unfinished tasks efficiently without redoing already finished storing tasks.

Next, FIG. 2 demonstrates a second preferred embodiment of the present invention. The data storage system with the snapshot-backup capability is applied to an interface, for example, a storage interface card 220. In the second preferred embodiment, the main system 200 includes a CPU 202, a memory 204, a north bridge chip 206, a south bridge chip 208, and slots 210 and 212. The main system 200 is electrically coupled to the storage interface card 220. Storage devices 230 and 232 are under the control of the storage interface card 220. Each of the storage devices 230 and 232 includes multiple data blocks, and multiple snapshot-backup blocks used for storing data. In an ordinary computer system, when a CPU and memory of a main system want to retrieve data or want to store data to its storage devices, storage commands can be transmitted to its storage devices via the north bridge chip and the south bridge chip which are electrically coupled to the main system. However, in the embodiment of the present invention, the storage commands will be transmitted to the storage interface card 220 first. The storage interface card 220 includes a storage controlling unit 222 and an I/O port 224. When the storage interface card 220 receives the storage commands from the main system 200, the storage interface card 220 manages to do the data storage or retrieving operations and to determine which devices to co-operate with. For instance, the storage controlling unit 222 orders the I/O port 224 to store or to retrieve data from the storage devices 230 and 232.

The snapshot-backup storage method of the second preferred embodiment of the present invention is described as follows. Upon receiving the storage commands and a copy of the newly stored data from the main system 200, the storage controlling unit 222 on the storage interface card 220 will determine which data blocks to store based on a block-mapping table. The block-mapping table can reside at the storage controlling unit 222 or can be held in the storage devices 230 or 232. By referring to the block-mapping table, the storage controlling unit 222 will be able to determine if the newly received data already has a previously stored data in the storage devices 230 or 232, or not.

Once the storage controlling unit 222 discovers an entry in the block-mapping table that stores an old copy of the newly received data, the storage controlling unit 222 will identify the differences between these two copies of data. Before the newly stored part of the data stores to the storage device 230 or 232, a snapshot-backup of the previously stored data is taken and stored to a snapshot-backup block region that is allocated in the storage devices 230 and 232. The mapping record of the snapshot-backup data is updated to the block-mapping table accordingly. After this, the newly stored data part that is identified by the storage controlling unit 222 is stored to the data blocks that stored the previously stored data. Again, the mapping record of the newly stored data is updated to the block-mapping table.

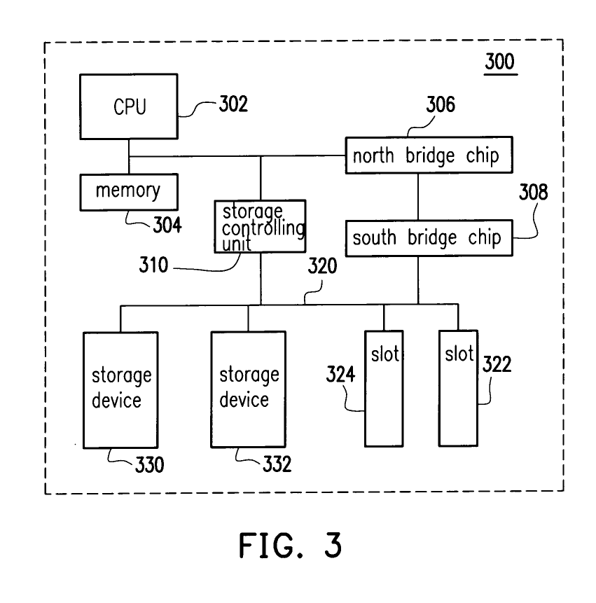

FIG. 3 portrays a circuit block diagram of a third preferred embodiment of the present invention. In this embodiment, the data storage system with the snapshot-backup capability is exploited to the design of a computer motherboard. The computer motherboard contains a main system 300 that can operate independently. The main system 300 includes a central processing unit (CPU) 302, a memory 304, a north bridge chip 306, a south bridge chip 308, a system bus 320, and slots 322 and 324 where interface cards or other peripheral devices can be installed. When a chip set of the storage controlling unit 310 is installed to the motherboard, the system bus 320 of the main system 300 can be used to connect to a storage device 330 or 332 so that the snapshot-backup capability can be carried out.

Similar to the second preferred embodiment of the present invention, the data that is requested to be stored by the main system 300 is sent to the storage controlling unit 310 through the system bus 320 and then is stored to the storage devices 330 or 320. This mechanism can reduce the workload from the CPU 302 of the main system 300. Each of the storage devices 330 or 332 includes multiple data blocks and multiple snapshot-backup blocks.

To achieve the purpose of reducing CPU workload, the storage controlling unit 310 needs to be equipped with the ability of comparing two sets of data that are the newly received data and the data stored in storage devices. The third preferred embodiment of the present invention is described as follows. When the storage controlling unit 310 receives storage command and the data requested to be stored is sent from the CPU 302 of the main system 300, the storage controlling unit 310 will search a block-mapping table for a data entry that represents an old copy of the newly received data.

If the search is a success, the storage controlling unit 310 will compare the newly received data with the data stored in the storage devices 330 and 332. If no difference can be found between these two copies of data, the newly received data is dropped, and no write-data-to-storage action is performed by the storage controlling unit 310. On the other hand, if any difference is found between these two copies of data, a snapshot-backup is taken on the difference of the old data that stored in the storage devices 330 or 320. The difference between the newly stored data and the previously stored data is then saved to one of the snapshot-backup blocks, and the corresponding mapping record is created and stored to the block-mapping table. After the snapshot-backup task is finished, through the system bus 320, the newly stored data is stored to the data blocks that hold the previsouly stored data in the storage devices 330 or 320, and the corresponding data mapping record is updated to the block-mapping table accordingly.

Note that although in the third preferred embodiment of the present invention, the storage controlling unit 310 and the south bridge chip 308 are separated, and they share the same system bus 320. It is commonly understood by those of ordinary skill in the art, that the function of the storage controlling unit 310 can be built in the south bridge chip 308, and even if the storage controlling unit 310 is separated from the south bridge chip 308, they may not have to share the same system bus 320 to achieve the same functionality.

Moreover, the technology of the present invention can be used with a multi storage disk array system (known as RAID system). Upon the use of a multi storage disk array, the snapshot-backup data can be stored in some fixed storage disks, and the primary data can be stored in the rest of the storage disks.

As a summary, the present invention provides the data storage system with a snapshot-backup capability. This mechanism reduces the common compatibility issues among an operating system (OS) and its file system. During conducting the snapshot-backup tasks, the present invention also saves the main system from doing calculation and I/O data transmission jobs. In addition, the present invention does not need to install extra storage management software, and the license fee for the software can be saved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A storage system with a snapshot-backup capability electrically coupled to a main system, comprising:
a storage device including at least a first data block and a second data block in response to the first data block; and
a storage controlling unit for receiving at least a newly stored data transmitted from the main system, in accordance with distribution of each data in said data blocks of the storage device, determining whether there is any difference found between the newly stored data and at least a previously stored data located in the first data block, thereby backing up each different previously stored data from the first data block to the second data block, and then storing the corresponding different newly stored data to the first data block where the different previously stored data is located as long as there is any one different data found between the newly and previously stored data.

2. The storage system of claim 1, wherein the storage device is as a multi-storage-disk array.

3. The storage system of claim 1, wherein the distribution of each data stored in said data blocks of the storage device is recorded in a block-mapping table.

4. The storage system of claim 3, wherein the backup process of the different previously stored data of the first data block to the second data block is recorded in the block-mapping table.

5. The storage system of claim 3, wherein the storing process of the corresponding different newly stored data to the first data block is recorded in the block-mapping table.

6. The storage system of claim 1, wherein the storage controlling unit includes at least a chip controller and an embedded driver software.

7. A storage system with a snapshot-backup capability electrically coupled to a main system, comprising:
a storage controlling unit for receiving and processing commands and data from the main system, disposed in an interface card; and
a storage device electrically coupled to an I/O port formed on the interface card, consisting of at least a first data block and a second data block in response to the first data block wherein
upon receiving at least a newly stored data transmitted from the main system, the storage controlling unit determines whether there is any difference found between the newly stored data and at least a previously stored data located in the first data block thereby backing up each difference previously stored data from the first data block to the second data block, and then storing the corresponding different newly stored data through the I/O port to the first data block where the different previously stored data is located as long as there is any one different data found between the newly and previously stored data.

8. The storage system of claim 7, wherein the storage device connected with the I/O port includes a multiple-disk data storage array.

9. The storage system of claim 7, wherein the storage controlling unit, according to a block-mapping table, identifies the difference between the newly received data and the previously stored data both which share the same entry defined in the block-mapping table.

10. The storage system of claim 9, wherein the backup process of the different previously stored data to the second data block is recorded in said block-mapping table.

11. The storage system of claim 9, wherein the storing process of the different newly stored data to the first data block is recorded in the block-mapping table.

12. The storage system of claim 7, wherein the storage controlling unit consists of at least a chip controller and an embedded driver software.

13. A storage system with a snapshot-backup capability electrically coupled to a motherboard having a main system, comprising:
a storage controlling unit for receiving and processing at least a newly stored data transmitted from the main system, disposed in the motherboard; and
a storage device electrically coupled to a system bus formed on the motherboard, consisting of at least a first data block and a second data block in response to the first data block wherein
upon receiving the newly stored data from the main system, the storage controlling unit determines whether there is any difference found between the newly stored data and at least a previously stored data located in the first data block thereby backing up each different previously stored data from the first data block to the second data block, and then storing the corresponding different newly stored data through the system bus of the motherboard to the first data block where said different previously stored data is located as long as there is any one different data found between the newly and previously stored data.

14. The storage system of claim 13, wherein the storage device connected with the system bus includes multiple-disk data storage array.

15. The storage system of claim 13, wherein the storage controlling unit, according to a block-mapping table, identifies the difference between the newly received data and the previously stored data both which share the same entry in the block-mapping table.

16. The storage system of claim 15, wherein the backup process of the different previously stored data to the second data block is recorded in the block-mapping table.

17. The storage system of claim 15, wherein the storing process of the different newly stored data to the first data block is recorded in the block-mapping table.

18. The storage system as described in claim 13, wherein the storage controlling unit includes at least a chip controller and an embedded driver software.

19. A storage method for facilitating a snapshot-backup capability within a storage system, the storage system having a storage device, the storage device having multiple primary data blocks and multiple backup data blocks, the method comprising:
receiving at least a newly stored data transmitted from a main system;
comparing the newly stored data with at least a previously stored data located on the data blocks, which is corresponding to the newly stored data by the storage system; and
backing up each different previously stored data from the primary data block to the backup data block, and then storing the corresponding different newly stored data to the primary data block where the different previously stored data is located as long as there is any one different data found between the newly and the previously stored data.

20. The storage method as defined in claim 19, further comprising:
examining a block-mapping table to find out the different previously stored data corresponding to each newly received data;
within the backup process of the different previously stored data, a mapping process of the previously stored data to the backup data block is recorded in the block-mapping table; and
within the storing process of the corresponding different newly stored data to the primary data block, a covering process of the different newly received stored data to the primary data block where the different previously stored data is located is recorded in the block-mapping table.
